(19) United States
(12) Patent Application Publication
(10) Pub. No.: US 2005/0144466 A1
(43) Pub. Date: Jun. 30, 2005

(54) Apparatus and method for rendering user data

(75) Inventors: Josephus Antonius Maria Versteijlen, Eindhoven (NL); Charles Leonardus Cornelius Maria Knibbeler, Eindhoven (NL); Robert Martinus Hendrikus Takken, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKIJKE PHILLIPS ELECTRONICS N.V.

(21) Appl. No.: 10/510,258

(22) PCT Filed: Mar. 20, 2003
(86) PCT No.: PCT/IB03/01103

(30) Foreign Application Priority Data
Apr. 10, 2002 (EP) 02076407.2

(51) Int. Cl. H04K 3/00

(52) U.S. Cl. 713/189; 380/1

(57) ABSTRACT

The invention relates to an apparatus and a method for rendering user data. In order to provide a higher level of protection against hacking of data during transport within a PC, a method is proposed according to the present invention comprising the steps of: —receiving encrypted user data and key data by a drive unit (2), —decrypting said user data using said key data, —re-encrypting said decrypted user data using a re-encryption key, —transmitting said re-encrypted user data and said re-encryption key from said drive unit (2) to an application unit (3), —decrypting said re-encrypted user data using said re-encryption key, —reproducing said decrypted user data into application data, —re-encrypting said application data, —transmitting said re-encrypted application data from said application unit (3) to said drive unit (2), —decrypting encrypted application data, —transmitting said decrypted application data from said drive unit (2) to a render unit (4), and —rendering said application data.

The invention relates to an apparatus and method for rendering user data. The invention relates further to a drive unit and an application unit for use in such an apparatus and to a computer program implementing said method. The invention relates particularly to the protection of content stored on a recordable or rewritable optical recording medium, such as audio data stored on a CD-RW.

At present it is possible to insert an audio CD into a CD-ROM or CD-RW drive and to playback audio on a PC. The PC reads the audio track, renders the digital music and sends it to the soundcard of the PC. The soundcard converts the digital music into audible sound. A well-known problem with this set up is that music can be hacked easily. The wav-files can be recorded to a PC's harddisc or copied directly to a recordable or rewritable record carrier such as a CD-R(W) using a multitude of recording applications. Hacking in this connection means the use of content against the intend of the digital rights management system, and/or tampering with information, deleting it, or even extracting it out of the realm of the digital rights management system without explicit permission from the content owner.

To provide solutions to this problem there are already a number of proposals for a copy protection system, such as the Content Scrambling System (CSS) and the Content Protection for Recordable Media (CPRM) system. According to such copy protection systems content stored on the recording medium is encrypted. When the user wants to playback data stored on the recording medium, e.g. to play audio tracks on a PC, the tracks are first re-encrypted before sending them to a PC application unit running a PC application for rendering. The PC application also obtains from the drive the decryption keys needed to decipher the tracks. The PC application now is able to decipher the tracks and playback the audio via the PC soundcard. This set up solves the problem of direct hacking of music content. Only two parties can gain access to content “in the clear”, i.e. unencrypted music: the drive and the (trusted) PC playback application. If either one is hacked, it can be revoked via various revocation mechanisms. In this way also that path to hacking has been blocked.

However, the weak point in this set up is the link to the soundcard: this link is digital and hence it is subject to piracy. Anybody having more than average knowledge of PC technology will be able to construct a software to make digital copies of the content. For instance, one could write a “virtual soundcard” that emulates a real soundcard to the PC playback application which in reality makes a copy of the digital content before sending it to the real soundcard.

It is therefore an object of the present invention to provide measures in a copy protection system comprising an apparatus for rendering user data which makes hacking of the user data harder or even impossible and which particularly secures the transport of data from the drive and/or the application unit to a render unit, such as a soundcard, against hacking.

This object is achieved according to the present invention by an apparatus as claimed in claim 1 comprising:
a drive unit comprising:
   means for receiving encrypted user data and key data,
   means for decrypting said user data using said key data,
   means for re-encrypting said decrypted user data,
   means for transmitting said re-encrypted user data from said drive unit to an application unit,
   means for decrypting encrypted application data received from said application unit, and
   means for transmitting said decrypted application data to a render unit for rendering said application data,
an application unit comprising:
   means for decrypting said re-encrypted user data,
   means for reproducing said decrypted user data into application data,
   means for re-encrypting said application data, and
   means for transmitting said re-encrypted application data from said application unit to said drive unit,
a render unit for rendering said application data.

A drive unit and an application unit for use in such an apparatus as well as a corresponding method are claimed in claims 9 to 11. A computer program comprising program code means for implementing the steps of the method according to the invention as claimed in claim 11 when said method is run on a computer is claimed in claim 12. Preferred embodiments of the invention are defined in the dependent claims.

The present invention is based on the idea to avoid a direct link between the application unit and the render unit and to avoid sending digital content directly from the application unit to the render unit. Instead, according to the present invention, the content which shall be rendered is, after reproducing and encrypting it, sent back from the application unit to the drive unit where it is finally decrypted and transmitted to the render unit for rendering it. Since the drive unit usually has no knowledge of file system, it is not capable of rendering a track file into digital content, e.g. it is not capable of decoding MP3-files. Therefore, the drive unit has to send the track files to the application unit first. Since a drive unit can not be hacked as easy as a PC application unit the level of protection, particularly the transport of the application data from the drive unit to the render unit is much higher than in the known embodiments.

According to a first preferred embodiment of the invention all connections between the drive unit and the application as well as between the drive unit and the render unit are digital connections over which the data are transmitted in digital form. In order to provide a high security against hacking of data during transport, it is preferred to provide Secure Authenticated Channels (SAC) as digital connections.

According to an alternative preferred embodiment of the invention as claimed in claim 4 the connection between the drive unit and the application unit is a digital connection, preferably a Secure Authenticated Channel, while the connection between the drive unit and the render unit is an analogue connection for transmitting the application data in analogue form. This has the advantage that digital content never comes “in the clear” which would be vulnerable to hacking. For converting the digital application data received from the application unit into analogue form the drive unit comprises a digital-analogue-converter which further enhances security since the application unit has no access to a secure D/A-converter other than the one in the drive unit. In this embodiment it would only be possible to make analogue copies of the analogue application data sent from the drive unit to the render unit. However, from a security point of view this possibility is deemed acceptable.

The security of the data transport within the apparatus according to the invention is based on several (re-)encryption and decryption steps. The required keys for (re-)encrypting and decrypting can be either provided from a trusted third party, such as a licensing authority, or can also be calculated from key data stored on the recording medium together with the encrypted user data, such as asset keys allowing the calculation of decryption and re-encryption keys. The application unit and/or the drive unit may thus comprise suitable means for calculating decryption and/or re-encryption keys.

The drive unit, the application unit and the render unit are preferably part of a computer such as a PC. The user is preferably stored in encrypted form on a recording medium, which is preferably an optical recording medium, in particular a CD, DVD or DVR disc, storing any kind of data for rendering, such as audio, video and/or software data.

The security of the apparatus and the method according to the invention rely on the security of the application unit, the drive unit and the connection in-between. However, if the application unit or the drive unit become compromised security-wise, they can be revoked according to a preferred embodiment of the invention comprising device revocation means. Such means may comprise a white list and/or a black list containing identifiers of devices which are not compromised (white list) or which are compromised (black list). Before allowing a unit to get access to data the identifier of the unit will then be checked against such a list.

Still further, the drive unit may comprise copy protection means, such as a watermark detector, for checking if the received application data have been tampered with.

The invention will now be explained more in detail with reference to the drawings, in which

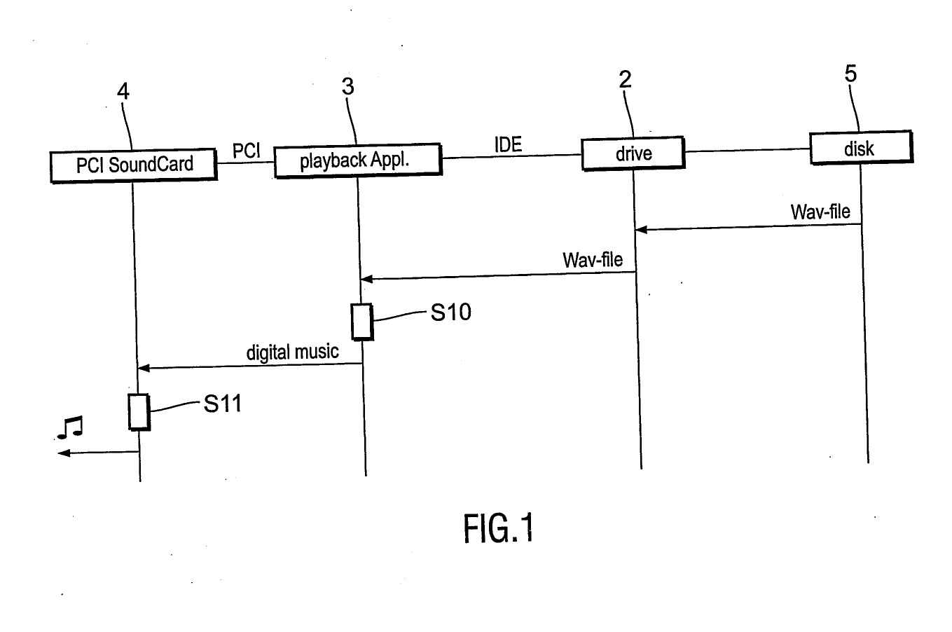

FIG. 1 shows the main steps for rendering content from a disc according to a known method,

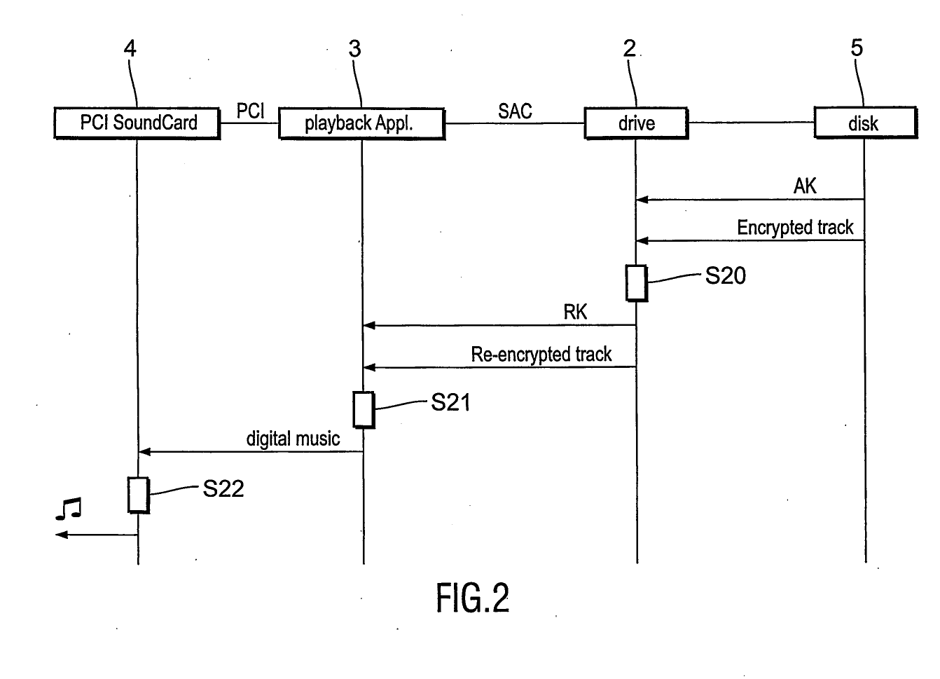

FIG. 2 shows the main steps for rendering content from a disc according to another known method,

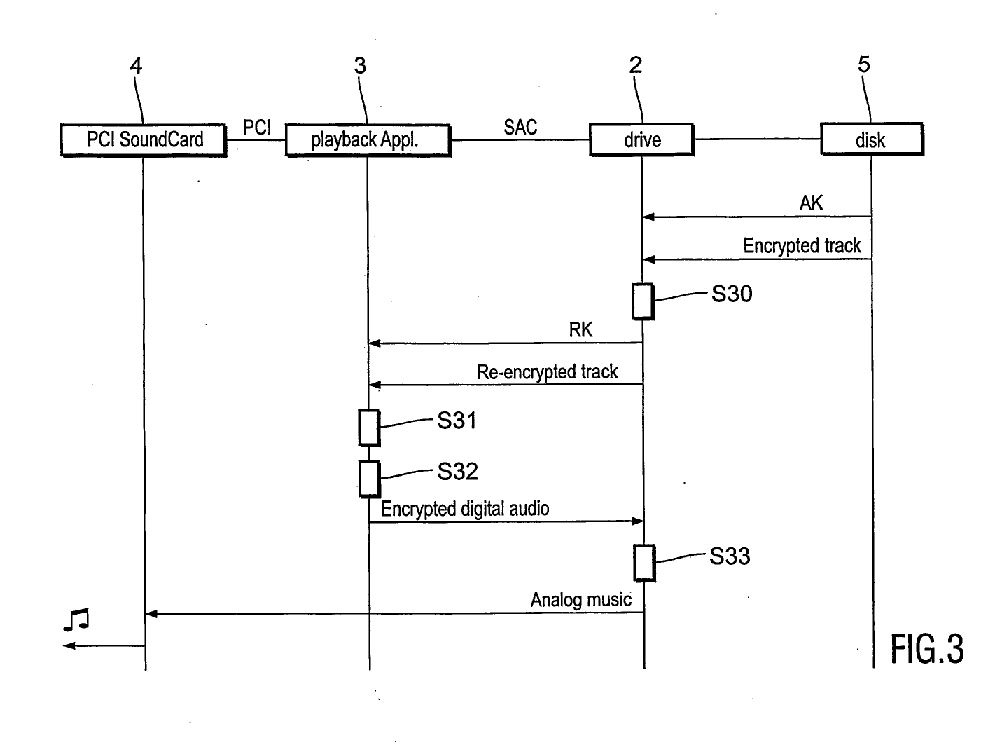

FIG. 3 shows the main steps for rendering content according to the present invention, and

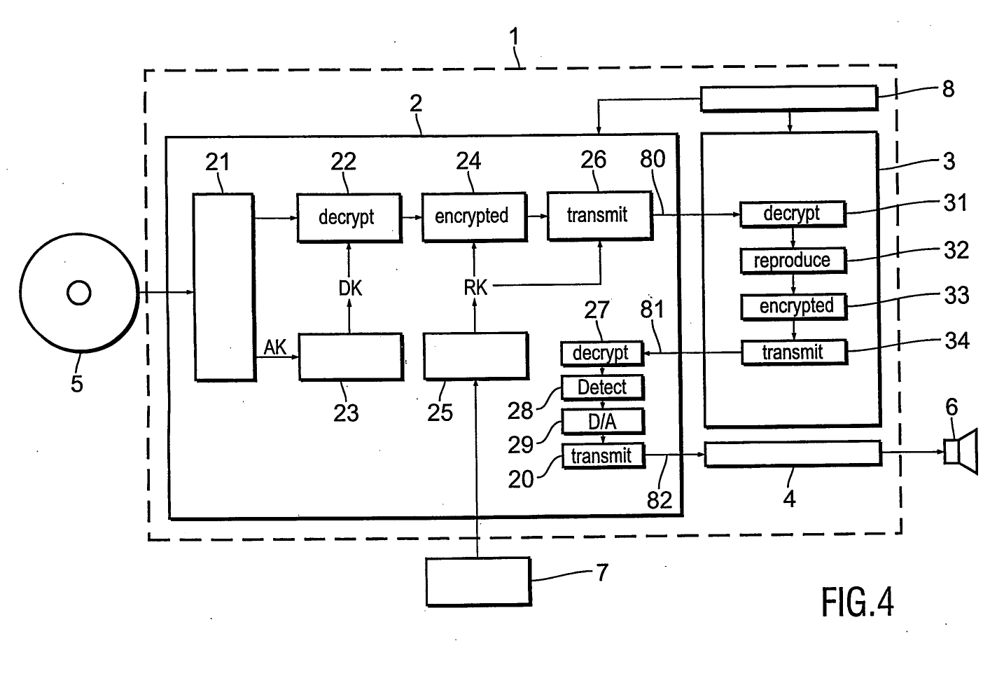

FIG. 4 shows a block diagram of an apparatus according to the present invention.

FIG. 1 illustrates the required steps for rendering content, e.g. audio, stored on a disc 5 using a PC 1 comprising a PCI soundcard 4, a playback application unit 3 and a drive unit 2. The audio CD 5 is inserted into the drive unit 2, which is e.g. a CD-ROM or CD-RW drive so that wav-files are transmitted from the disc via the drive 2 to the playback application unit 3 over the IDE bus. The application unit 3 then renders the read audio track file into digital audio (step S10) and sends it via the PCI bus to the soundcard 4. The soundcard 4 then converts the digital music into audible sound (step S11) which may then be rendered.

The music stored on the disc 5 can thus be hacked easily. The wav-files can be recorded to the PC's harddisc or copied directly to a recordable or rewritable information carrier using a multitude of known recording applications.

An improved known method is illustrated in FIG. 2. According to this improved system content stored on the disc 5 is encrypted. Thus, when a user wants to play audio tracks on the PC 1, the encrypted track files are first read by the drive unit 4 together with corresponding asset keys AK so that the drive unit 4 can decrypt the track files and re-encrypt them again (step S20) before transmitting it to the playback application unit 3 via a secure authenticated channel SAC for rendering. The application unit 3 also obtains from the drive unit 4 via the SAC the re-encryption key needed to decipher the track files. The application unit 3 (step S21) decrypts the track files, renders it into digital audio and sends it via the PCI bus to the soundcard 2 where the digital music is converted (step S22) into analogue data for playback.

This set-up solves the problem of direct hacking of music content. Only two parties can gain access to content “in the clear”, i.e. unencrypted music: the trusted drive unit 2 and the trusted playback application unit 3. If either one is hacked, it can be revoked via various revocation mechanisms so that also that path to hacking has been blocked.

However, the weak point in this set up is the link to the soundcard 4: this link is digital and hence it is subject to piracy. It will be able to construct software for making digital copies of the music by, for instance, writing a virtual soundcard that emulates a real soundcard to the playback application unit 3, but in reality makes a copy of the digital music before sending it to the soundcard 4. Although this way of hacking music was also possible in the embodiment shown in FIG. 1 there was no need for it since copying of data stored on a CD via CD write applications was already possible.

The method according to the invention avoiding these problems is illustrated in FIG. 3. Steps S30 and S31 are identical to steps S20 and S21 shown in FIG. 2 resulting in reproduced digital data. However, according to the present invention, the digital link from the application unit 3 to the soundcard 4 is removed. Instead of sending digital audio to the soundcard 4, the trusted application unit 3 encrypts the digital audio (step S32) and sends it back to the drive unit 2. The drive unit 2 performs decryption and D/A-conversion (step S33); the resulting analogue audio data is finally sent to the soundcard 4 for rendering.

FIG. 4 shows a block diagram of an apparatus according to the present invention in more detail. When a user wants to render data stored on the disc 5 the drive unit 2 accesses the disc 5 using reading means 21 for reading encrypted content and corresponding asset keys AK. A key generation unit 23 is used to generate required decryption keys DK from the asset keys AK so that the encrypted content can be decrypted by decryption unit 22. For security reasons the decrypted content is again re-encrypted in a re-encryption unit 24 using a re-encryption key RK which is either generated in a key generation unit 25 or received from a trusted third party 7, such as a licensing authority. The re-encrypted content along with the re-encryption key RK is then transmitted by a transmission unit 26 via a secure authenticated channel 80 over the IDE bus of the PC 1 to an application unit 3.

Therein, a decryption unit 31 is used for decryption using the received re-encryption key RK. The decrypted content is thereafter reproduced by a reproduction unit 32, i.e. in case of digital data track files are rendered into digital audio data, generally called application data. Such digital data are thereafter re-encrypted by a re-encryption unit 33 using the same or a different re-encryption key RK as previously used, and the result, the re-encrypted application data, is transmitted by a transmission unit 34 via a secure authenticated channel 81 over the IDE bus back to the drive unit 2.

Therein the digital data is decrypted by a decryption unit 27. Advantageously, a watermark detector 28 is used for checking if the data have been tampered with. Finally, the digital data are converted into analogue data by a D/A-converter 29 and transmitted by a transmitter 20 over an analogue line 82 to the render unit 4, i.e. in case of audio data to the soundcard 4 for rendering by a loudspeaker 6.

The drive unit 2 has no knowledge of file systems. Consequently, the drive unit 2 is not capable for rendering a track file into digital data, e.g. MP3-decoding. Therefore, the drive unit 2 has to send the track files to the application unit 3 first. Further, the application unit 3 has no access to a secure D/A-converter other than the one in the drive unit 2. The advantages of this set up are obvious: the digital content never comes in the “clear”, i.e. is vulnerable to hacking. Thus, the user data is protected in all units as well as during transport, particularly to the soundcard 4.

It should be noted that the security of this set-up relies on the security of the application unit 3, the security of the connections 80, 81 and the security of the drive unit 2. However, if the application unit 3 or the drive unit 2 become compromised security-wise, they can be revoked by a revocation unit 8, preferably containing a white list and/or black list of compliant and/or compromised devices. Therefore, this set-up can be made completely secure.

The present invention can be applied in any PC-based system containing a drive unit and a render unit, aiming to playback any kind of user data. Alternatively to the analogue connection between the drive unit 2 and the render unit 4, the application data could also be transmitted in digital form via a digital line, e.g. a secure authenticated channel preventing that the various software layers in the PC do not have access to the digital content, except for the trusted application. Further, in addition to checking a watermark in the decrypted digital application data, watermarks could also be embedded by the drive unit 2 prior to conversion of the data to analogue form.

The encrypted user data and the key data do not necessarily need to be stored on a recording medium, but can also be received from any other storage medium such as a PC's hard disc or downloaded by the Internet. The encrypted user data and the key data can also be transmitted separately and/or via separate channels to the drive unit 2 or even directly to the playback application unit 3.

According to the present invention the path the data go is changed, i.e. according to the present invention go along the path from the drive unit to the playback application unit, back to the drive unit, and finally to the render unit. Important is a save link between the drive unit and the render unit which should be tamper-free.

1. Apparatus for rendering user data, comprising:
a drive unit (2) comprising:
means (21) for receiving encrypted user data and key data,
means (22) for decrypting said user data using said key data,
means (24) for re-encrypting said decrypted user data,
means (26) for transmitting said re-encrypted user data from said drive unit (2) to an application unit (3),
means (27) for decrypting encrypted application data received from said application unit (4), and
means (20) for transmitting said decrypted application data to a render unit (4) for rendering said application data,
an application unit (3) comprising:
means (31) for decrypting said re-encrypted user data,
means (32) for reproducing said decrypted user data into application data,
means (33) for re-encrypting said application data, and
means (34) for transmitting said re-encrypted application data from said application unit (3) to said drive unit (2),
a render unit (4) for rendering said application data.

2. Apparatus according to claim 1, wherein said drive unit (2) and/or said application unit (3) comprises means (23, 25) for calculating decryption and/or re-encryption keys.

3. Apparatus according to claim 1, further comprising a digital connection (80, 81, 82) between said application unit (3) and said drive unit (2) and between said drive unit (2) and said render unit for transmitting said application data in digital form.

4. Apparatus according to claim 1, further comprising:
a digital connection (80, 81) between said application unit (3) and said drive unit (2) for transmitting said application data between said application unit (3) to said drive unit (2) in digital form,
a digital-analogue-converter in said drive unit for converting said digital application data into analogue application data, and
an analogue connection (82) between said drive unit (2) and said render unit (4) for transmitting said analogue application data from said drive unit (2) to said render unit (4).

5. Apparatus according to claim 1, wherein said drive unit (2), said application unit (3) and said render unit (4) are part of a computer (1).

6. Apparatus according to claim 1, wherein said encrypted user data are stored on a recording medium (5) and wherein said recording medium (5) is an optical recording medium, in particular a CD, DVD or DVR disk, storing audio, video and/or software data.

7. Apparatus according to claim 1, further comprising device revocation means (8) for checking if the application unit (3) and/or the drive unit (2) have been compromised and for revoking a compromised application unit (39 and/or drive unit (2).

8. Apparatus according to claim 1, wherein said drive unit (2) further comprises copy protection means (28), in particular a watermark detector, for checking if said received application data have been tampered with.

9. Drive unit for use in an apparatus for rendering user data as claimed in claim 1, comprising:
means (21) for receiving encrypted user data and key data,
means (22) for decrypting said user data using said key data,
means (24) for re-encrypting said decrypted user data,
means (26) for transmitting said re-encrypted user data from said drive unit (2) to an application unit (3) for decrypting said re-encrypted user data, reproducing said decrypted user data into application data and re-encrypting said application data,
means (27) for decrypting encrypted application data received from said application unit (3), and
means (20) for transmitting said decrypted application data to a render unit (4) for rendering said application data.

10. Application unit for use in an apparatus for rendering user data as claimed in claim 1, comprising:
means (31) for decrypting re-encrypted user data received from a drive unit for receiving encrypted user data and key data, decrypting said user data using said key data, re-encrypting said decrypted user data and transmitting said re-encrypted user data from to said application unit,
means (32) for reproducing said decrypted user data into application data,
means (33) for re-encrypting said application data, and
means (34) for transmitting said re-encrypted application data to said drive unit for decrypting said encrypted application data and for transmitting said decrypted application data from said drive unit to a render unit for rendering said application data.

11. Method of rendering user data, comprising the steps of:
receiving encrypted user data and key data by a drive unit (2),
decrypting said user data using said key data,
re-encrypting said decrypted user data,
transmitting said re-encrypted user data from said drive unit (2) to an application unit (3),
decrypting said re-encrypted user data,
reproducing said decrypted user data into application data,
re-encrypting said application data,
transmitting said re-encrypted application data from said application unit (3) to said drive unit (2),
decrypting encrypted application data, transmitting said decrypted application data from said drive unit (2) to a render unit (4), and
rendering said application data.

12. Computer program comprising program code means for implementing the steps of the method as claimed in claim 11 when said method is run on a computer.
